(19) United States
(12) Patent Application Publication
(10) Pub. No.: US 2022/0019914 A1
(43) Pub. Date: Jan. 20, 2022

(54) PREDICTIVE DATA ANALYSIS TECHNIQUES FOR CROSS-TEMPORAL ANOMALY DETECTION

(71) Applicant: Optum, Inc., Minnetonka, MN (US)

(72) Inventors: Daniel William James, Costa Mesa, CA (US); Rahul Bhaskar, Rancho Santa Margarita, CA (US); Daryl Seiichi Furuyama, Irvine, CA (US)

(21) Appl. No.: 16/931,670

(22) Filed: Jul. 17, 2020

(51) Int. Cl. G06N 5/04; G06F 16/23; G06N 20/00

(52) U.S. Cl. CPC G06N 5/04; G06N 20/00; G06F 16/2379

(57) ABSTRACT

There is a need for more effective and efficient predictive anomaly detection. This need can be addressed by, for example, solutions for performing anomaly detection using an anomaly detection machine learning model. In one example, a method includes: identifying a plurality of event records; for each event record of the plurality of event records, determining a temporally-related event code data object based at least in part on a temporally-related subset of the one or more event codes that is associated with the event record; generating one or more event record profiles based on each temporally-related event code data object; processing the one or more event record profiles using an anomaly detection machine learning model to generate one or more anomaly detection predictions; and performing one or more prediction-based actions based at least in part on the one or more anomaly detections.

### BACKGROUND

Various embodiments of the present invention address technical challenges related to performing anomaly detections. Various embodiments of the present invention address the shortcomings of existing anomaly detection systems and disclose various techniques for efficiently and reliably performing anomaly detection.

### BRIEF SUMMARY

In general, embodiments of the present invention provide methods, apparatus, systems, computing devices, computing entities, and/or the like for performing predictive anomaly detection. Certain embodiments of the present invention utilize systems, methods, and computer program products that perform predictive anomaly detections by using at least one of temporally-related event code data objects, event record profiles, and anomaly detection machine learning models.

In accordance with one aspect, a method is provided. In one embodiment, the method comprises: identifying a plurality of event records, wherein each event record of the plurality of event records is associated with an event period of one or more event periods, an event date of one or more event dates, and an event code of one or more event codes; for each event record of the plurality of event records, determining a temporally-related event code data object based at least in part on a temporally-related subset of the one or more event codes that is associated with the event record, wherein: (i) each event code in the temporally-related subset for a corresponding event record of the one or more event records is associated with at least one event record of the one or more event records that occurs within the event period of the corresponding event record, and (ii) each event code in the temporally-related subset for a corresponding event record of the one or more event records is associated with at least one event record of the one or more event records that occurs prior to the event date of the corresponding event record; generating one or more event record profiles, wherein: (i) each event record profile of the one or more event record profiles is associated with an event period of the one or more event periods, and (ii) each event record profile of the one or more event record profiles describes a related subset of each temporally-related event code data object for an event record of the plurality of event records that is associated with the event period for the event record profile; processing the one or more event record profiles using an anomaly detection machine learning model to generate one or more anomaly detection predictions; and performing one or more prediction-based actions based at least in part on the one or more anomaly detections.

In accordance with another aspect, a computer program product is provided. The computer program product may comprise at least one computer-readable storage medium having computer-readable program code portions stored therein, the computer-readable program code portions comprising executable portions configured to: identify a plurality of event records, wherein each event record of the plurality of event records is associated with an event period of one or more event periods, an event date of one or more event dates, and an event code of one or more event codes; for each event record of the plurality of event records, determine a temporally-related event code data object based at least in part on a temporally-related subset of the one or more event codes that is associated with the event record, wherein: (i) each event code in the temporally-related subset for a corresponding event record of the one or more event records is associated with at least one event record of the one or more event records that occurs within the event period of the corresponding event record, and (ii) each event code in the temporally-related subset for a corresponding event record of the one or more event records is associated with at least one event record of the one or more event records that occurs prior to the event date of the corresponding event record; generate one or more event record profiles, wherein: (i) each event record profile of the one or more event record profiles is associated with an event period of the one or more event periods, and (ii) each event record profile of the one or more event record profiles describes a related subset of each temporally-related event code data object for an event record of the plurality of event records that is associated with the event period for the event record profile; process the one or more event record profiles using an anomaly detection machine learning model to generate one or more anomaly detection predictions; and perform one or more prediction-based actions based at least in part on the one or more anomaly detections.

In accordance with yet another aspect, an apparatus comprising at least one processor and at least one memory including computer program code is provided. In one embodiment, the at least one memory and the computer program code may be configured to, with the processor, cause the apparatus to: identify a plurality of event records, wherein each event record of the plurality of event records is associated with an event period of one or more event periods, an event date of one or more event dates, and an event code of one or more event codes; for each event record of the plurality of event records, determine a temporally-related event code data object based at least in part on a temporally-related subset of the one or more event codes that is associated with the event record, wherein: (i) each event code in the temporally-related subset for a corresponding event record of the one or more event records is associated with at least one event record of the one or more event records that occurs within the event period of the corresponding event record, and (ii) each event code in the temporally-related subset for a corresponding event record of the one or more event records is associated with at least one event record of the one or more event records that occurs prior to the event date of the corresponding event record; generate one or more event record profiles, wherein: (i) each event record profile of the one or more event record profiles is associated with an event period of the one or more event periods, and (ii) each event record profile of the one or more event record profiles describes a related subset of each temporally-related event code data object for an event record of the plurality of event records that is associated with the event period for the event record profile; process the one or more event record profiles using an anomaly detection machine learning model to generate one or more anomaly detection predictions; and perform one or more prediction-based actions based at least in part on the one or more anomaly detections.

### BRIEF DESCRIPTION OF THE DRAWINGS

Having thus described the invention in general terms, reference will now be made to the accompanying drawings, which are not necessarily drawn to scale, and wherein:

FIG. 1 provides an exemplary overview of an architecture that can be used to practice embodiments of the present invention.

FIG. 2 provides an example predictive data analysis computing entity in accordance with some embodiments discussed herein.

FIG. 3 provides an example external computing entity in accordance with some embodiments discussed herein.

FIG. 4 is a flowchart diagram of an example process for performing anomaly detection in accordance with some embodiments discussed herein.

FIG. 5 provides an operational example of performing anomaly detection for a particular event record profile in accordance with some embodiments discussed herein.

FIG. 6 is a flowchart diagram of an example process for generating a particular event record profile in accordance with some embodiments discussed herein.

FIG. 7 is a flowchart diagram of an example process for generating an anomaly detection in accordance with some embodiments discussed herein.

FIG. 8 is a flowchart diagram of an example process for detecting a neighboring subset of event record profiles for a particular event record profile in accordance with some embodiments discussed herein.

FIG. 9 provides an operational example of a multi-dimensional embedding space for an anomaly detection machine learning model in accordance with some embodiments discussed herein.

FIG. 10 provides an operational example of an anomaly detection user interface in accordance with some embodiments discussed herein.

### DETAILED DESCRIPTION

Various embodiments of the present invention now will be described more fully hereinafter with reference to the accompanying drawings, in which some, but not all, embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout. Moreover, while certain embodiments of the present invention are described with reference to predictive data analysis, one of ordinary skill in the art will recognize that the disclosed concepts can be used to perform other types of data analysis.

### I. OVERVIEW

Various embodiments of the present invention address technical shortcomings of existing anomaly detection models that process temporally dynamic input data by introducing techniques that effectively and efficiently integrate temporal inferences into input preprocessing steps of an anomaly detection machine learning model. Existing machine learning models configured to perform predictive anomaly detection on predictive input data generally suffer from major drawbacks when it comes to drawing and utilizing predictive inferences based on temporally varied nature of input data. This is in part because existing temporally-aware machine learning models have not shown to effectively perform anomaly detections across time, while non-temporally-aware machine learning models fail to perform effective cross-temporal predictive inferences. Thus, there is a continuing technical need for more efficient and effective predictive anomaly detection solutions.

Various embodiments of the present invention address the technical shortcomings of existing anomaly detection models that process temporally dynamic input data via using solutions that first preprocess input data for an machine learning model by using cross-temporal predictive inferences that both utilize intra-period relationships of various event records within an event period and inter-period relationships of various event periods, and subsequently process the preprocessed input using an anomaly detection machine learning model to generate temporally-aware anomaly detections. The proposed solutions have many advantages, including that they utilize computationally resource-efficient machine learning models as opposed to more resource-efficient deep learning models that need extensive amounts of data and resources to train, that they provide outputs that are probabilistic in nature by utilizing distance measures provided by the anomaly detection machine learning model to generate neighboring subsets of event record profiles and generate inclusion ratios for particular target codes based on the distribution of those target codes within the neighboring subset, and that they provide interpretable outputs by providing inclusion ratios of particular target codes within neighboring subsets as explanation metadata for particular anomaly detections. Additionally, various embodiments of the present invention enable bi-directional comparison against neighbors to both detect the presence of anomalous conditions and the anomalous absence of expected conditions based on neighbors (as opposed to needing separate methods). The embodiments also support confirmation of existing conditions contained within the group, when compared to external documentation (e.g. medical chart) for cross document discrepancies (e.g. conditions contained within claims and present amongst neighbors, but missing from the chart).

Accordingly, by utilizing the above-noted techniques and various similar techniques introduced herein, various embodiments of the present invention improve training efficiency, output utility, and output interpretability of performing predictive anomaly detection using machine learning techniques. In doing so, various embodiments of the present invention improve the effectiveness and efficiency of performing predictive anomaly detection using machine learning techniques, and make important technical contribution to the field of data anomaly detection and to the field of data pattern recognitions.

Exemplary applications of the various aspects of the present invention include but are not limited to a pipeline for the automatic identification of risk anomalies to augment current clinical rules-based systems. The noted anomaly detection outputs can be used to increase the efficiency of current programs and could potentially be used for automatic submission of missed diagnoses. In some embodiments, three primary steps are performed for automatic identification of risk anomalies: aggregating and summarizing clinical touchpoints over a service year into a “chart profile”; identifying risk anomalies through transactional equivalency; and prioritizing charts for review and/or for automatic submission.

The first step noted above may include an aggregation and summarization process that ingests input data from input data sources and creates clinical sentences, which are time-ordered sequences of medical codes and results through each service year. Some embodiments create a timeline of member conditions using clinical history, where each condition-service date combination act as the start of a new transaction period (as transactions change in response to a new diagnosis), and where the transaction periods are further broken apart into chart profiles by separating member transactions into member-provider-specific transactions, and further where uninformative terms are removed based on inverse document frequency, and further where each corresponding chart profile is vectorized (given a numeric representation via term frequency, word embeddings, sentence embeddings, etc.).

As part of the second step of the process noted above, the system applies a distance metric (e.g., Euclidean, cosine, Jaccard, etc.) and finds the nearest neighbors for each chart profile. Neighbors can be other chart profiles from the same service year or other chart profiles from a previous year. The set difference of event codes is then computed between the current chart profile and its nearest neighbors. Specifically, the system may detect conditions that similar chart profiles have that the target chart profile does not have. A risk anomaly propensity may then be calculated by voting. The number of neighbors that had a certain new condition divided by the total number of neighbors may be used as a metric for the noted voting process. Risk anomalies may then then compared to all the known conditions for a member and known conditions may be removed. An output consisting of a member, a new event code, and a risk anomaly propensity may then be generated by this step.

As part of the third step of the process noted above, the metadata from a medical chart (e.g., provider specialty metadata, number of claim provider codes, provider coding history metadata) will be combined with the risk anomaly output. High likelihood risk anomalies may also be automatically submitted or used for confirmation. Charts may then be ranked and targeted according to the chart metadata and risk anomaly propensity. The highest charts may then be prioritized for retrieval and coding. An optimization technique (i.e. linear programming, ant colony, etc.) may be then be used to process the updated propensity scores and the suspected event codes and route the medical charts to an ideal coder. Specific factors considered in the routing process may include coder efficacy, coder quality, coder familiarity with specific types of charts, and coder familiarity with specific types of conditions, member risk gaps, and chart condition support.

### II. DEFINITIONS

The term “event record” may refer to a data object that describes properties associated with occurrence of a real-world event. An example of an event record is a data object that describe properties of a medical services delivery report, such as a physician-generated medical claim, a pharmacy-generated medical claim, a hospital-generated medical claim, a laboratory-generated medical claim, and/or the like. In the medical services delivery context, exemplary properties described by an event record may include event codes such as Current Procedural Terminology (CPT) codes, non-risk adjusting diagnosis codes, quality descriptor values, service modifier values, service duration descriptor values, National Drug Codes (NDCs), drug quantity descriptor values, drug prescription duration descriptor values, Logical Observation Identifiers Names and Codes (LOINCs), lab result descriptor values, heart rate descriptor values, respiratory descriptor values, body mass index descriptor values, height descriptor values, weight descriptor values, blood pressure descriptor values, oxygen saturation (SPO2) descriptor values, gender descriptor values, age descriptor values, race descriptor values, and/or the like. In some embodiments, an event record is indexed/stored as a row in a relational databases. In some embodiments, an event record is indexed/stored as a node in a graph-based database. In some embodiments, an event record is indexed/stored as an object in an object-oriented database. In some embodiments, an event record is indexed/stored as a file in a file-based semi-structured database such as a JavaScript Object Notation (JSON) database or an Extended Markup Language (XML) database.

The term “event period” may refer to a data object that describes a period of time associated with a corresponding event record, where the period of time is then used to aggregate various event records associated with the period of time in order to perform predictive anomaly detection with respect to the event records associated with the period of time. In other words, the event period may describe a period of time within which patterns across the event records are deemed to be representative of real-world patterns, which in turn leads to an expectation that anomalous patterns across the event records of a particular event period represent real-world anomalous patterns deemed of interest to a predictive anomaly detection process. An example of an event period is a date of service (DOS) year for reporting medical documentation associated with a group of medical claims deemed associated with the DOS year. In some embodiments, a computing entity associated with a health insurance provider institution is configured to report medical documentation associated with a group of medical claims deemed associated with a particular DOS of year to an external institution, such as to the Center for Medicare and Medicaid Services (CMS). In some of the noted embodiments, medical claims associated with a particular DOS year are analyzed to determine whether the aggregation of the noted medical claims includes medical documentation gap, where the noted determination may be determined based on a determination related to whether the aggregation of the noted medical claims for a DOS year presents anomalous date patterns when compared to the aggregation of medical claims for other DOS years.

The term “event date” may refer to a data object that describes a unit period of time within an event period of a corresponding event record that is associated with the event record. For example, in an embodiment within which a particular event record is associated with a medical claim and an event period is associated with a DOS year, the event date of an event record may describe a particular DOS day within a DOS year that is associated with the medical claim. In the noted embodiment, a temporal sequence of DOS days within a particular DOS year may be utilized to generate cross-temporal inferences across the various DOS days of the particular DOS year. Thus, various embodiments of the present invention provide robust predictive anomaly detection solutions that both enable inter-period cross-temporal inferences between the event records of various event periods as well as intra-period cross-temporal inferences between the various event records of a single event period. By using the noted techniques, various embodiments of the present invention enable effective and efficient predictive anomaly detection techniques for an event-record-based data environment that integrate predictive inferences determined based on various types of temporal relationships described by the event-record-based data environment.

The term “event code” may refer to a data object that describes a property of an event record that can be used to generate an event record profile that can in turn be used to map the event record to a multi-dimensional space. For example, in an embodiment within which a particular event record is associated with a particular medical claim that occurs within a particular DOS day of a particular DOS year, the event code of the event record may describe a diagnosis code, a pharmaceutical product identification code, a service, and/or hierarchical condition category (HCC) associated with the particular medical claim. Examples of event codes include Current Procedural Terminology (CPT) codes, non-risk adjusting diagnosis codes, quality descriptor values, service modifier values, service duration descriptor values, National Drug Codes (NDCs), drug quantity descriptor values, drug prescription duration descriptor values, Logical Observation Identifiers Names and Codes (LOINCs), lab result descriptor values, heart rate descriptor values, respiratory descriptor values, body mass index descriptor values, height descriptor values, weight descriptor values, blood pressure descriptor values, oxygen saturation (SPO2) descriptor values, gender descriptor values, age descriptor values, race descriptor values, and/or the like.

The term “temporally-related event code data object” may refer to a data object that describes each event code data object that is associated with an event record deemed to be temporally related to a particular event record. For example, in some embodiments, a first event record is deemed related to a second event record if: (i) the event date of the first event record occurs prior to the event date of the second event record, and (ii) the event date of the first event record occurs within the event period of the second event record. As another example, in some embodiments, a first event record is deemed related to a second event record if: (i) the event date of the first event record occurs on or prior to the event date of the second event record, and (ii) the event date of the first event record occurs within the event period of the second event record. In some embodiments, in an exemplary embodiment in which event records describe medical claims and where each described medical claim is associated with a DOS year and a DOS day, a first medical claim may be deemed temporally related to a second medical claim if, in addition to the two medical claims being related to the same person/patient/member identifier: (i) the DOS day of the first medical occurs prior to the DOS day of the second medical claim, and (ii) the DOS day of the first medical claim occurs within the DOS year of the second medical claim. In some embodiments, in an exemplary embodiment in which event records describe medical claims and where each described medical claim is associated with a DOS year and a DOS day, a first medical claim may be deemed temporally related to a second medical claim if, in addition to the two medical claims being related to the same person/patient/member identifier: (i) the DOS day of the first medical occurs on or prior to the DOS day of the second medical claim, and (ii) the DOS day of the first medical claim occurs within the DOS year of the second medical claim.

The term “event record profile” may refer to a data object that describes temporally-related event codes for the event records of a corresponding event period in accordance with a temporal sequence of the noted event records. For example, given an event period that is associated with an event record E1 that is in turn associated with the event codes C1, C2, and C3, as well as an event record E2 that is in turn associated with the event codes C1, C2, C3, and C4, the event record profile for the noted event period may describe the following temporal sequence of event records: C1, C2, C3, C1, C2, C3, and C4. In an exemplary embodiment in which event codes describe HCCs for medical claims, and where each medical claim is associated with a DOS day of a DOS year, the event record profile for a DOS year that is associated with a first medical claim that occurs prior to a second medical claim may include a listing of the service codes for the first medical claim followed by the service codes of the second medical claim. As noted above, event record profiles may be used to generate inferences about inter-period cross-temporal inferences between the event records of various event periods, which in turn enables effective and efficient predictive anomaly detection techniques for an event-record-based data environment that integrate predictive inferences determined based on various types of temporal relationships described by the event-record-based data environment.

The term “anomaly detection machine learning model” may refer to a data object that describes parameters and/or hyper-parameters of a machine learning model that uses mappings of a group of event record profiles to a multi-dimensional embedding space to determine predicted subject-matter correlations between the event record profiles, where the noted subject-matter correlations may then in turn be used to determine anomaly predictions for the mapped event record profiles. For example, the anomaly detection machine learning model may be used to determine a neighboring subset for each mapped event record profile, where it may be assumed that a mapped event record profile should have a distribution of target codes that statistically corresponds to the distribution of event codes across the event record profiles in the neighboring subset for the mapped event record profile. In some embodiments, the anomaly detection machine learning model is a clustering model.

The term “anomaly detection” may refer to a data object that describes the likelihood that a target code is missing from an event record profile for an event period and/or the likelihood that a target code currently associated with an event record profile for an event period should not be part of the event record profile. In some embodiments, anomaly detections may be determined using an anomaly detection machine learning model, e.g., by mapping a group of event record profiles to a multi-dimensional embedding space associated with the anomaly detection machine learning model to determine predicted subject-matter correlations between the event record profiles, followed by using the noted subject-matter correlations to determine anomaly predictions for the mapped event record profiles.

The term “target code” may refer to a data object that describes a property of an event record profile that may be obtained by comparing the event record profile to other event record profiles having ground-truth target codes. An example of a target code is an HCC code. In some embodiments, ground-truth HCC codes may be determined based on historical medical chart review result data, and may be used to determine HCCs of new event record profiles by utilizing an anomaly detection machine learning model as described above.

### III. COMPUTER PROGRAM PRODUCTS, METHODS, AND COMPUTING ENTITIES

Embodiments of the present invention may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatus, systems, computing devices, computing entities, and/or the like. As such, embodiments of the present invention may take the form of an apparatus, system, computing device, computing entity, and/or the like executing instructions stored on a computer-readable storage medium to perform certain steps or operations. Thus, embodiments of the present invention may also take the form of an entirely hardware embodiment, an entirely computer program product embodiment, and/or an embodiment that comprises combination of computer program products and hardware performing certain steps or operations.

Embodiments of the present invention are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

### IV. EXEMPLARY SYSTEM ARCHITECTURE

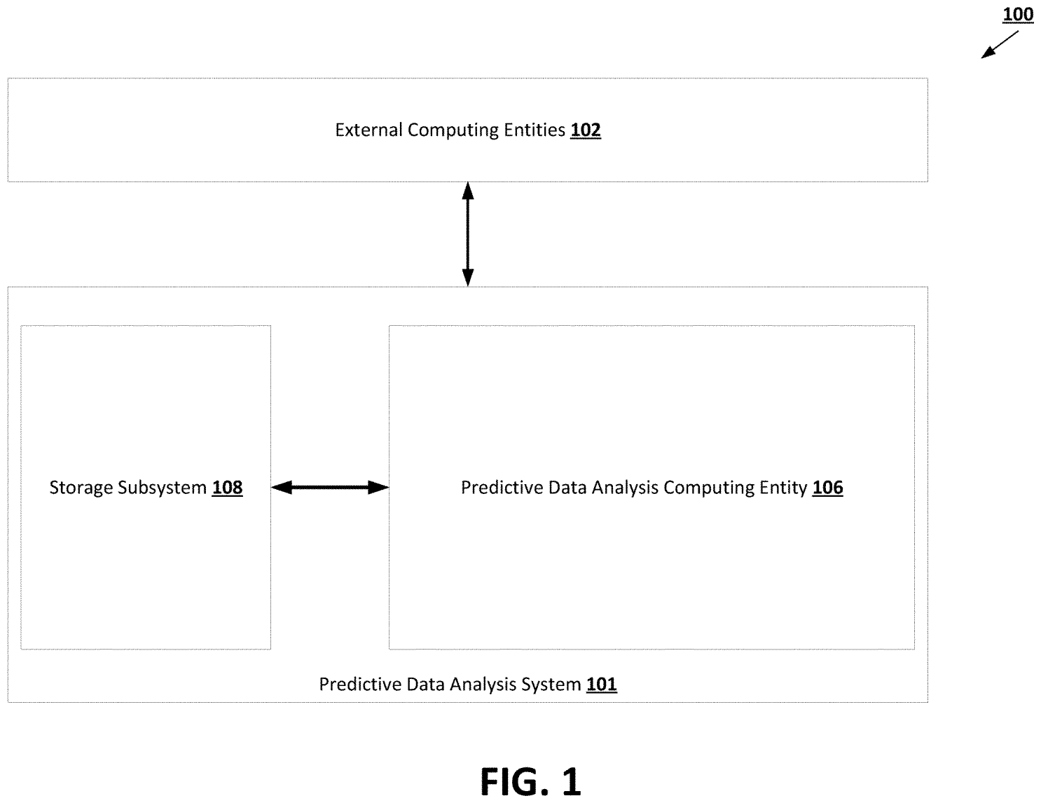

FIG. 1 is a schematic diagram of an example architecture 100 for performing predictive data analysis. The architecture 100 includes a predictive data analysis system 101 configured to receive predictive data analysis requests from external computing entities 102, process the predictive data analysis requests to generate predictions, provide the generated predictions to the external computing entities 102, and automatically perform prediction-based actions based at least in part on the generated predictions. An example of a prediction that can be generated using the predictive data analysis system 101 is a prediction about detecting when medical transaction records for a patient profile in a given service period (e.g., in a given service year) include medical documentation gaps.

In some embodiments, predictive data analysis system 101 may communicate with at least one of the external computing entities 102 using one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software and/or firmware required to implement it (such as, e.g., network routers, and/or the like).

The predictive data analysis system 101 may include a predictive data analysis computing entity 106 and a storage subsystem 108. The predictive data analysis computing entity 106 may be configured to receive predictive data analysis requests from one or more external computing entities 102, process the predictive data analysis requests to generate predictions corresponding to the predictive data analysis requests, provide the generated predictions to the external computing entities 102, and automatically perform prediction-based actions based at least in part on the generated predictions.

The storage subsystem 108 may be configured to store input data used by the predictive data analysis computing entity 106 to perform predictive data analysis as well as model definition data used by the predictive data analysis computing entity 106 to perform various predictive data analysis tasks. The storage subsystem 108 may include one or more storage units, such as multiple distributed storage units that are connected through a computer network. Each storage unit in the storage subsystem 108 may store at least one of one or more data assets and/or one or more data about the computed properties of one or more data assets. Moreover, each storage unit in the storage subsystem 108 may include one or more non-volatile storage or memory media including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

### Exemplary Predictive Data Analysis Computing Entity

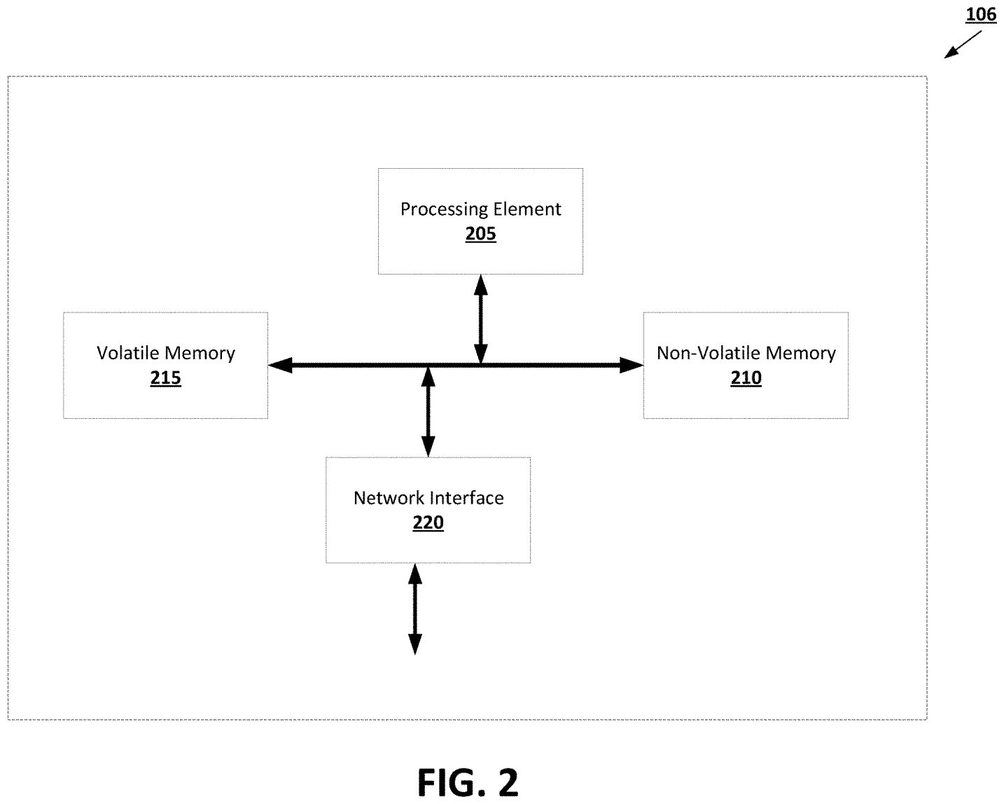

FIG. 2 provides a schematic of a predictive data analysis computing entity 106 according to one embodiment of the present invention. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

As indicated, in one embodiment, the predictive data analysis computing entity 106 may also include one or more communications interfaces 220 for communicating with various computing entities, such as by communicating data, content, information, and/or similar terms used herein interchangeably that can be transmitted, received, operated on, processed, displayed, stored, and/or the like.

As shown in FIG. 2, in one embodiment, the predictive data analysis computing entity 106 may include, or be in communication with, one or more processing elements 205 (also referred to as processors, processing circuitry, and/or similar terms used herein interchangeably) that communicate with other elements within the predictive data analysis computing entity 106 via a bus, for example. As will be understood, the processing element 205 may be embodied in a number of different ways.

For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present invention when configured accordingly.

In one embodiment, the predictive data analysis computing entity 106 may further include, or be in communication with, non-volatile media (also referred to as non-volatile storage, memory, memory storage, memory circuitry and/or similar terms used herein interchangeably). In one embodiment, the non-volatile storage or memory may include one or more non-volatile storage or memory media 210, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity—relationship model, object model, document model, semantic model, graph model, and/or the like.

In one embodiment, the predictive data analysis computing entity 106 may further include, or be in communication with, volatile media (also referred to as volatile storage, memory, memory storage, memory circuitry and/or similar terms used herein interchangeably). In one embodiment, the volatile storage or memory may also include one or more volatile storage or memory media 215, including, but not limited to, RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 205. Thus, the databases, database instances, database management systems, data, applications, programs, program modules, scripts, source code, object code, byte code, compiled code, interpreted code, machine code, executable instructions, and/or the like may be used to control certain aspects of the operation of the predictive data analysis computing entity 106 with the assistance of the processing element 205 and operating system.

As indicated, in one embodiment, the predictive data analysis computing entity 106 may also include one or more communications interfaces 220 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the predictive data analysis computing entity 106 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the predictive data analysis computing entity 106 may include, or be in communication with, one or more input elements, such as a keyboard input, a mouse input, a touch screen/display input, motion input, movement input, audio input, pointing device input, joystick input, keypad input, and/or the like. The predictive data analysis computing entity 106 may also include, or be in communication with, one or more output elements (not shown), such as audio output, video output, screen/display output, motion output, movement output, and/or the like.

### Exemplary External Computing Entity

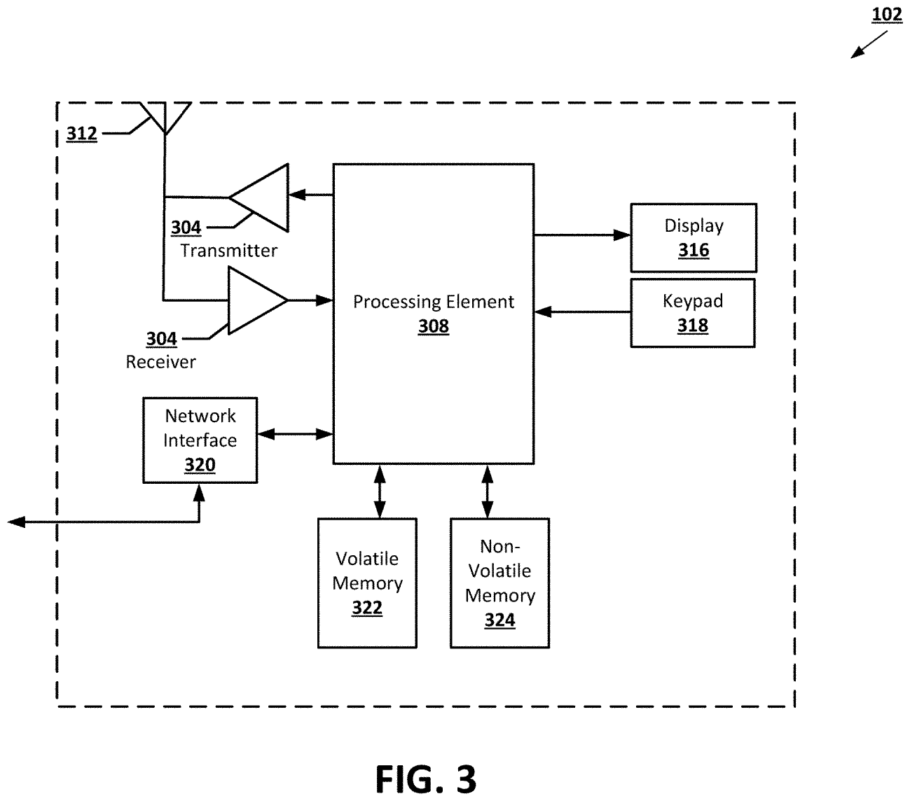

FIG. 3 provides an illustrative schematic representative of an external computing entity 102 that can be used in conjunction with embodiments of the present invention. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. External computing entities 102 can be operated by various parties. As shown in FIG. 3, the external computing entity 102 can include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may include signaling information/data in accordance with air interface standards of applicable wireless systems. In this regard, the external computing entity 102 may be capable of operating with one or more air interface standards, communication protocols, modulation types, and access types. More particularly, the external computing entity 102 may operate in accordance with any of a number of wireless communication standards and protocols, such as those described above with regard to the predictive data analysis computing entity 106. In a particular embodiment, the external computing entity 102 may operate in accordance with multiple wireless communication standards and protocols, such as UMTS, CDMA2000, 1×RTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the external computing entity 102 may operate in accordance with multiple wired communication standards and protocols, such as those described above with regard to the predictive data analysis computing entity 106 via a network interface 320.

Via these communication standards and protocols, the external computing entity 102 can communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The external computing entity 102 can also download changes, add-ons, and updates, for instance, to its firmware, software (e.g., including executable instructions, applications, program modules), and operating system.

According to one embodiment, the external computing entity 102 may include location determining aspects, devices, modules, functionalities, and/or similar words used herein interchangeably. For example, the external computing entity 102 may include outdoor positioning aspects, such as a location module adapted to acquire, for example, latitude, longitude, altitude, geocode, course, direction, heading, speed, universal time (UTC), date, and/or various other information/data. In one embodiment, the location module can acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data can be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data can be determined by triangulating the external computing entity's 102 position in connection with a variety of other systems, including cellular towers, Wi-Fi access points, and/or the like. Similarly, the external computing entity 102 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning aspects can be used in a variety of settings to determine the location of someone or something to within inches or centimeters.

The external computing entity 102 may also comprise a user interface (that can include a display 316 coupled to a processing element 308) and/or a user input interface (coupled to a processing element 308). For example, the user interface may be a user application, browser, user interface, and/or similar words used herein interchangeably executing on and/or accessible via the external computing entity 102 to interact with and/or cause display of information/data from the predictive data analysis computing entity 106, as described herein. The user input interface can comprise any of a number of devices or interfaces allowing the external computing entity 102 to receive data, such as a keypad 318 (hard or soft), a touch display, voice/speech or motion interfaces, or other input device. In embodiments including a keypad 318, the keypad 318 can include (or cause display of) the conventional numeric (0-9) and related keys (#, *), and other keys used for operating the external computing entity 102 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

The external computing entity 102 can also include volatile storage or memory 322 and/or non-volatile storage or memory 324, which can be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile storage or memory can store databases, database instances, database management systems, data, applications, programs, program modules, scripts, source code, object code, byte code, compiled code, interpreted code, machine code, executable instructions, and/or the like to implement the functions of the external computing entity 102. As indicated, this may include a user application that is resident on the entity or accessible through a browser or other user interface for communicating with the predictive data analysis computing entity 106 and/or various other computing entities.

In another embodiment, the external computing entity 102 may include one or more components or functionality that are the same or similar to those of the predictive data analysis computing entity 106, as described in greater detail above. As will be recognized, these architectures and descriptions are provided for exemplary purposes only and are not limiting to the various embodiments.

In various embodiments, the external computing entity 102 may be embodied as an artificial intelligence (AI) computing entity, such as an Amazon Echo, Amazon Echo Dot, Amazon Show, Google Home, and/or the like. Accordingly, the external computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

### V. EXEMPLARY SYSTEM OPERATIONS

Various embodiments of the present invention address the technical shortcomings of existing anomaly detection models that process temporally dynamic input data via using solutions that first preprocess input data for an machine learning model by using cross-temporal predictive inferences that both utilize intra-period relationships of various event records within an event period and inter-period relationships of various event periods, and subsequently process the preprocessed input using an anomaly detection machine learning model to generate temporally-aware anomaly detections. The proposed solutions have many advantages, including that they utilize computationally resource-efficient machine learning models as opposed to more resource-efficient deep learning models that need extensive amounts of data and resources to train, that they provide outputs that are probabilistic in nature by utilizing distance measures provided by the anomaly detection machine learning model to generate neighboring subsets of event record profiles and generate inclusion ratios for particular target codes based on the distribution of those event codes within the neighboring subset, and that they provide interpretable outputs by providing inclusion ratios of particular target codes within neighboring subsets as explanation metadata for particular anomaly detections.

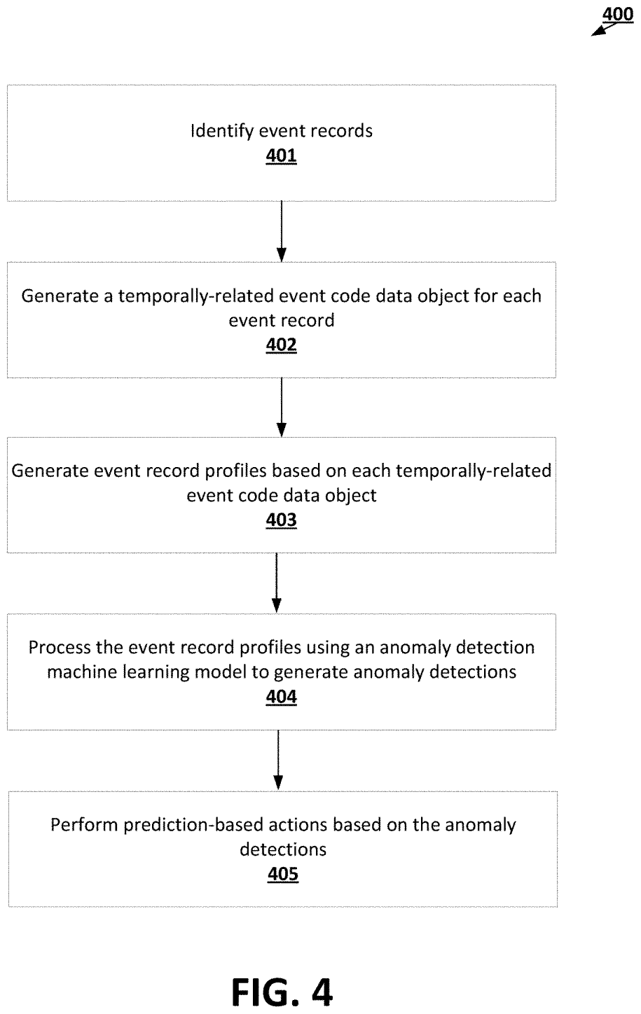

FIG. 4 is a flowchart diagram of an example process 400 for performing predictive anomaly detection. Via the various steps/operations of the process 400, the predictive data analysis computing entity 106 can perform anomaly detection in a manner that integrates predictive inferences performed based on temporal relationships between event records in an event processing system. An exemplary practical application of the process 400 is detecting when medical transaction records for a patient profile in a given service period (e.g., in a given service year) include medical documentation gaps.

The process 400 begins at step/operation 401 when the predictive data analysis computing entity 106 identifies a group of event records. In some embodiments, the predictive data analysis computing entity 106 identifies event records associated with a predictive entity (e.g., with a patient profile), where each event record may be associated with an event period, an event date, and an event code.

In general, an event record may describe properties associated with occurrence of a real-world event. An example of an event record is a data object that describe properties of a medical services delivery report, such as a physician-generated medical claim, a pharmacy-generated medical claim, a hospital-generated medical claim, a laboratory-generated medical claim, and/or the like. In the medical services delivery context, exemplary properties described by an event record may include event codes such as Current Procedural Terminology (CPT) codes, non-risk adjusting diagnosis codes, quality descriptor values, service modifier values, service duration descriptor values, National Drug Codes (NDCs), drug quantity descriptor values, drug prescription duration descriptor values, Logical Observation Identifiers Names and Codes (LOINCs), lab result descriptor values, heart rate descriptor values, respiratory descriptor values, body mass index descriptor values, height descriptor values, weight descriptor values, blood pressure descriptor values, oxygen saturation (SPO2) descriptor values, gender descriptor values, age descriptor values, race descriptor values, and/or the like. In some embodiments, an event record is indexed/stored as a row in a relational databases. In some embodiments, an event record is indexed/stored as a node in a graph-based database. In some embodiments, an event record is indexed/stored as an object in an object-oriented database. In some embodiments, an event record is indexed/stored as a file in a file-based semi-structured database such as a JavaScript Object Notation (JSON) database or an Extended Markup Language (XML) database.

The event period of an event record may describe a period of time associated with the event record, where the period of time is then used to aggregate various event records associated with the period of time in order to perform predictive anomaly detection with respect to the event records associated with the period of time. In other words, the event period may describe a period of time within which patterns across the event records are deemed to be representative of real-world patterns, which in turn leads to an expectation that anomalous patterns across the event records of a particular event period represent real-world anomalous patterns deemed of interest to a predictive anomaly detection process. An example of an event period is a date of service (DOS) year for reporting medical documentation associated with a group of medical claims deemed associated with the DOS year. In some embodiments, a computing entity associated with a health insurance provider institution is configured to report medical documentation associated with a group of medical claims deemed associated with a particular DOS of year to an external institution, such as to the Center for Medicare and Medicaid Services (CMS). In some of the noted embodiments, medical claims associated with a particular DOS year are analyzed to determine whether the aggregation of the noted medical claims includes medical documentation gap, where the noted determination may be determined based on a determination related to whether the aggregation of the noted medical claims for a DOS year presents anomalous date patterns when compared to the aggregation of medical claims for other DOS years.

In contrast, the event date of an event record may describe a unit period of time within an event period of the event record that is associated with the event record. For example, in an embodiment within which a particular event record is associated with a medical claim and an event period is associated with a DOS year, the event date of an event record may describe a particular DOS day within a DOS year that is associated with the medical claim. In the noted embodiment, a temporal sequence of DOS days within a particular DOS year may be utilized to generate cross-temporal inferences across the various DOS days of the particular DOS year. Thus, various embodiments of the present invention provide robust predictive anomaly detection solutions that both enable inter-period cross-temporal inferences between the event records of various event periods as well as intra-period cross-temporal inferences between the various event records of a single event period. By using the noted techniques, various embodiments of the present invention enable effective and efficient predictive anomaly detection techniques for an event-record-based data environment that integrate predictive inferences determined based on various types of temporal relationships described by the event-record-based data environment. An event code of an event record may describe a property of an event record that can be used to generate an event record profile that can in turn be used to map the event record to a multi-dimensional space. For example, in an embodiment within which a particular event record is associated with a particular medical claim that occurs within a particular DOS day of a particular DOS year, the event code of the event record may diagnosis code, a pharmaceutical product identification code, a service, and/or hierarchical condition category (HCC) associated with the particular medical claim. Examples of event codes include Current Procedural Terminology (CPT) codes, non-risk adjusting diagnosis codes, quality descriptor values, service modifier values, service duration descriptor values, National Drug Codes (NDCs), drug quantity descriptor values, drug prescription duration descriptor values, Logical Observation Identifiers Names and Codes (LOINCs), lab result descriptor values, heart rate descriptor values, respiratory descriptor values, body mass index descriptor values, height descriptor values, weight descriptor values, blood pressure descriptor values, oxygen saturation (SPO2) descriptor values, gender descriptor values, age descriptor values, race descriptor values, and/or the like.

At step/operation 402, the predictive data analysis computing entity 106 determines a temporally-related event code data object for each event record in the group of event records. In some embodiments, the predictive data analysis computing entity 106 determines a temporally-related subset of the group of event records for the event record and proceeds to aggregate each event code associated with an event record in the temporally-related subset to generate the temporally-related event code data object for the event record.

In general, a temporally-related event code data object for a particular event record describes each event code data object that is associated with an event record deemed to be temporally related to the particular event record. For example, in some embodiments, a first event record is deemed related to a second event record if: (i) the event date of the first event record occurs prior to the event date of the second event record, and (ii) the event date of the first event record occurs within the event period of the second event record. As another example, in some embodiments, a first event record is deemed related to a second event record if: (i) the event date of the first event record occurs on or prior to the event date of the second event record, and (ii) the event date of the first event record occurs within the event period of the second event record. In some embodiments, in an exemplary embodiment in which event records describe medical claims and where each described medical claim is associated with a DOS year and a DOS day, a first medical claim may be deemed temporally related to a second medical claim if: (i) the DOS day of the first medical occurs prior to the DOS day of the second medical claim, and (ii) the DOS day of the first medical claim occurs within the DOS year of the second medical claim. In some embodiments, in an exemplary embodiment in which event records describe medical claims and where each described medical claim is associated with a DOS year and a DOS day, a first medical claim may be deemed temporally related to a second medical claim if: (i) the DOS day of the first medical occurs on or prior to the DOS day of the second medical claim, and (ii) the DOS day of the first medical claim occurs within the DOS year of the second medical claim.

Returning to FIG. 4, in some embodiments, the temporally-related subset of event records for a particular event record that is used to generate the temporally-related event code data object for the particular event record includes a set of event records that, in addition to being deemed temporally-related to the particular event record, have one or more non-temporal properties in common with the particular event record. For example, given a particular event record that describes a particular medical claim associated with a particular DOS day of a particular DOS year, the temporally-related subset of medical claims for the particular medical claim include a group of medical claims that, in addition to being associated with DOS days that occur within the particular DOS year but prior to the particular DOS day, have a common patient identifier and/or a common medical service provider identifier with the particular medical claim. In some embodiments, ensuring that the temporally-related subset of event records for a particular event record only includes event records that have one or more non-temporal properties in common with the particular event record can be accomplished in a variety of ways. For example, in some embodiments, the group of event records determined at step/operation 401 may be filtered to exclude any event records that do not have all of the one or more non-temporal properties in common with the particular event record. As another example, in some embodiments, during the process of determining the temporally-related subset of event records for a particular event record, the set of candidate event records may first be filtered to exclude any event records that do not have all of the one or more non-temporal properties in common with the particular event record. As yet another example, in some embodiments, following determining an initial temporally-related subset of event records for a particular event record, the initial temporally-related subset of event records may be filtered to exclude any event records that do not have all of the one or more non-temporal properties in common with the particular event record.

Thus, while in some embodiments each temporally-related subset for a temporally-related event code data object that is associated with a corresponding event record comprises each event record of the one or more event records that occurs within the event period for the corresponding event record and that is associated with the event code for the corresponding event record, in other embodiments each temporally-related subset for a temporally-related event code data object that is associated with a corresponding event record of may comprise each event record of the one or more event records that occurs within the event period for the corresponding event record, that is associated with the event code for the corresponding event record, and that is associated with the provider identifier for the corresponding event record.

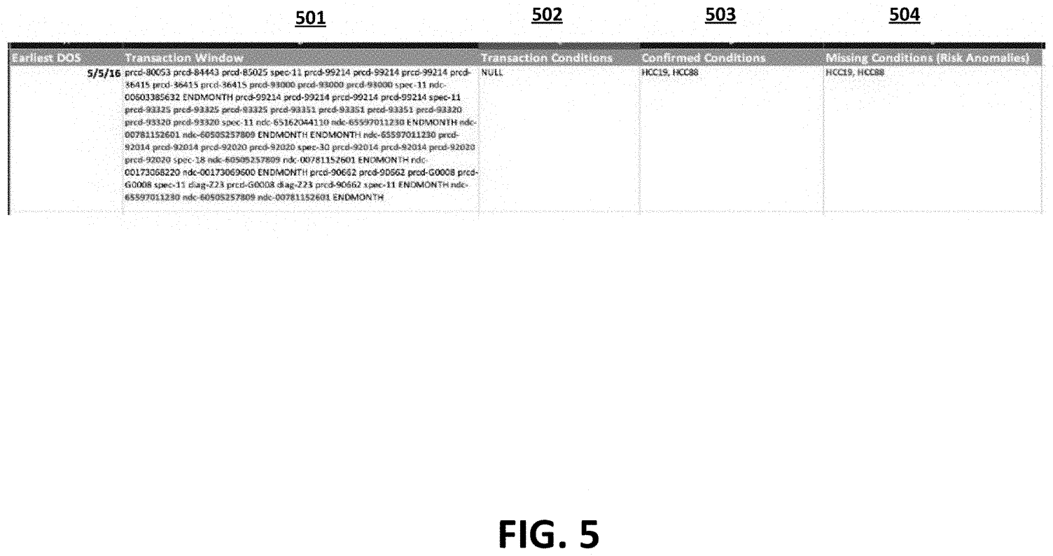

At step/operation 403, the predictive data analysis computing entity 106 generates an event record profile for an event period based on each temporally-related event code data object for an event record that is associated with the event period. For example, in some embodiments, for each DOS year, the predictive data analysis computing entity 106 may aggregate each temporally-related service code vector for an event record that is associated with the DOS year in order to generate the event record profile for the DOS year. As an exemplary embodiment, given the event records depicted in the event code aggregation data object 500 of FIG. 5, the event record profile for the DOS year 2016 may be determined based on the temporally-related service code code vector for the event records associated with the fourth, sixth, and seventh rows, while the DOS year 2017 may be determined based on the temporally-related service code code vector for the event records associated with the remaining rows.

In general, an event record profile may describe temporally-related event codes for the event records of a corresponding event period in accordance with a temporal sequence of the noted event records. For example, given an event period that is associated with an event record E1 that is in turn associated with the event codes C1, C2, and C3, as well as an event record E2 that is in turn associated with the event codes C1, C2, C3, and C4, the event record profile for the noted event period may describe the following temporal sequence of event records: C1, C2, C3, C1, C2, C3, and C4. In an exemplary embodiment in which event codes describe service codes for medical claims, and where each medical claim is associated with a DOS day of a DOS year, the event record profile for a DOS year that is associated with a first medical claim that occurs prior to a second medical claim may include a listing of the service codes for the first medical claim followed by the service codes of the second medical claim. As noted above, event record profiles may be used to generate inferences about inter-period cross-temporal inferences between the event records of various event periods, which in turn enables effective and efficient predictive anomaly detection techniques for an event-record-based data environment that integrate predictive inferences determined based on various types of temporal relationships described by the event-record-based data environment.

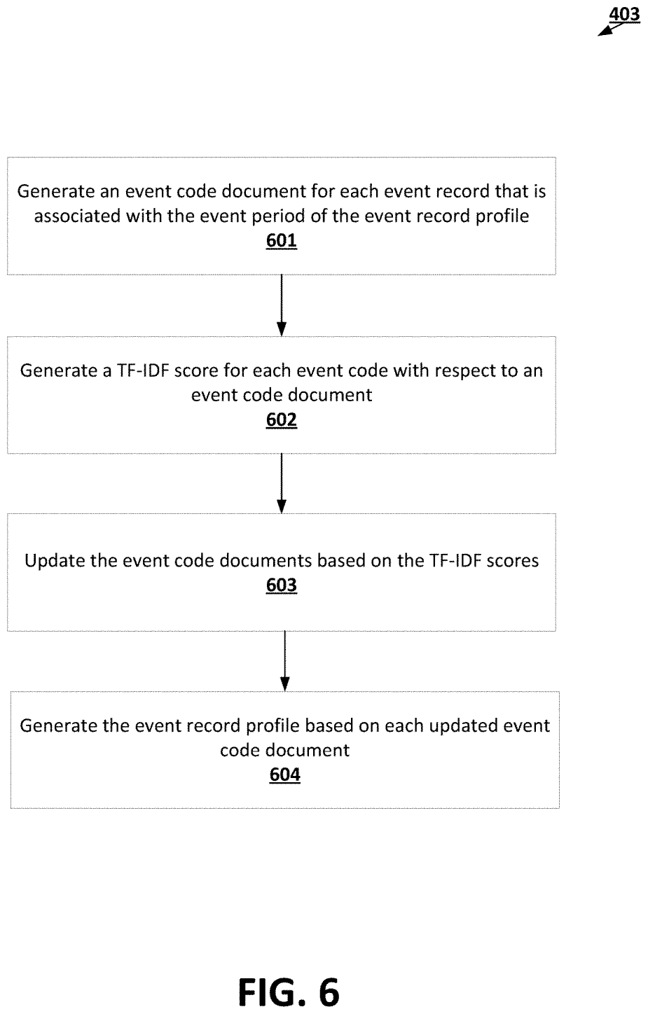

In some embodiments, step/operation 403 may be performed in accordance with the process depicted in FIG. 6 to generate a particular event record profile for a particular event period. The process depicted in FIG. 6 begins at step/operation 601 when the predictive data analysis computing entity 106 generates an event code document for each event record that is associated with the event period of the event record profile. In some embodiments, the predictive data analysis computing entity 106 aggregates each event code described by the temporally-related event code data object for an event record that is associated with the event period. For example, given an event period that is associated with an event record E1 that is in turn associated with the event codes C1, C2, and C3, an event record E2 that is in turn associated with the event codes C1, C2, C3, and C4, an event record E3 that is in turn associated with the event codes C1, C2, C3, C4, C5, and C6, the event code documents for the event period include: (i) an event code document for the event record E1 that describes the event codes C1, C2, and C3, (ii) an event code document for the event record E2 that describes the event codes C1, C2, C3, and C4, and (iii) an event code document for the event record E3 that describes the event codes C1, C2, C3, C4, C5, and C6.

At step/operation 602, the predictive data analysis computing entity 106 generates a term-frequency-inverse-domain-frequency (TF-IDF) score for each event code with respect to an event code document that describes the relative value of the frequency of occurrence of the event code in the event code document and the frequency of occurrence of the event code in other event code documents.

For example, given an event period that is associated with an event code document D1 for an event record E1 that describes the event codes C1, C2, and C3, an event code document D2 for an event record E2 that describes the event codes C1, C2, C3, and C4, an event code document D3 for an event record E3 that describes the event codes C1, C2, C3, C4, C5, and C6, the predictive data analysis computing entity 106 may generate a TF-IDF score for the event code C1 with respect to the event code document D1, a TF-IDF score for the event code C1 with respect to the event code document D2, a TF-IDF score for the event code C1 with respect to the event code document D3, a TF-IDF score for the event code C2 with respect to the event code document D1, a TF-IDF score for the event code C2 with respect to the event code document D2, a TF-IDF score for the event code C2 with respect to the event code document D3, a TF-IDF score for the event code C3 with respect to the event code document D1, a TF-IDF score for the event code C3 with respect to the event code document D2, a TF-IDF score for the event code C3 with respect to the event code document D3, a TF-IDF score for the event code C4 with respect to the event code document D1, a TF-IDF score for the event code C4 with respect to the event code document D2, a TF-IDF score for the event code C4 with respect to the event code document D3, a TF-IDF score for the event code C5 with respect to the event code document D1, a TF-IDF score for the event code C5 with respect to the event code document D2, a TF-IDF score for the event code C5 with respect to the event code document D3, a TF-IDF score for the event code C5 with respect to the event code document D1, a TF-IDF score for the event code C5 with respect to the event code document D2, a TF-IDF score for the event code C5 with respect to the event code document D3, a TF-IDF score for the event code C6 with respect to the event code document D1, a TF-IDF score for the event code C6 with respect to the event code document D2, and a TF-IDF score for the event code C6 with respect to the event code document D3.

At step/operation 603, the predictive data analysis computing entity 106 update the event code documents by removing an event code from an event document if the TF-IDF score of the event code with respect to the event document satisfies (e.g., falls below) a TF-IDF score threshold value. In some embodiments, by using step/operation 603, the predictive data analysis computing entity 106 can infer those event codes deemed unimportant because of their frequent occurrence and exclude the noted event codes from the event code documents that are used to generate the event record profiles. In some embodiments, the TF-IDF score threshold value is determined based on a hyper-parameter of the predictive data analysis computing entity 106, such as a hyper-parameter that is determined statistically using pre-runtime-provided system configuration data, determined dynamically using runtime-provided system configuration data, determined statistically based on a statistical distribution of historical TF-IDF values across various recorded time periods, determined dynamically based on a statistical distribution of historical TF-IDF values across various recorded time periods, determined statistically using a pre-runtime-executed trained machine learning model, determined dynamically using a runtime-executed trained machine learning model, and/or the like.

For example, given an event code document that initially includes the event codes C1, C2, C3, and C4, if the event code document is associated with a first TF-IDF score in relation to an event code C1, a second TF-IDF score in relation to an event code C2, a third TF-IDF score in relation to an event code C3, and a fourth TF-IDF score in relation to an event code C4, and further if the first TF-IDF score and the third TF-IDF score fall below the TF-IDF score threshold value, the updated event code document may describe the event codes C1 and C4. As another example, given an event code document that initially includes the event codes C1, C2, C3, C4, C5, and C6, if the event code document is associated with a first TF-IDF score in relation to an event code C1, a second TF-IDF score in relation to an event code C2, a third TF-IDF score in relation to an event code C3, a fourth TF-IDF score in relation to an event code C4, a fifth TF-IDF score in relation to an event code C5, and a sixth TF-IDF score in relation to an event code C6, and further if the first TF-IDF score and the second TF-IDF score fall below the TF-IDF score threshold value, the updated event code document may describe the event codes C3, C4, C5, and C6.

At step/operation 604, the predictive data analysis computing entity 106 generates the particular event record profile by aggregating each updated event code document. In some embodiments, to generate the particular event record profile, the predictive data analysis computing entity 106 first aggregates each set of event code documents described by an event code document in accordance with a temporal sequence of the event records that are associated with the event code documents and subsequently generates a vector representation (e.g., a numeric representation via term frequency, word embeddings, sentence embeddings, and/or the like) to each aggregated data object. For example, given a first updated event code document D1 associated with an event record E1 that occurs within an event period P1 and a second updated event code document D2 associated with an event record E2 that occurs within the event period P1, if the first updated event code document D1 describes the event codes C3 and C4 while the second updated event code document D2 describes the event codes C4 and C6, and further if the event date of the event record E1 occurs prior to the event record of the event record E2, then the event record profile for the event period P1 may be determined based on a numeric representation of the following sequence of event codes C3, C4, C4, and C6.

Returning to FIG. 4, at step/operation 404, the predictive data analysis computing entity 106 processes the event record profiles using an anomaly detection machine learning model to generate one or more anomaly detections. In some embodiments, the predictive data analysis computing entity 106 maps a particular event record profile to a multi-dimensional embedding space associated with the anomaly detection machine learning model to detect a neighboring subset of event record profiles described by the multi-dimensional embedding space for the particular event record profile, and uses the target codes associated with the event record profiles in the neighboring subset to determine predictive inferences about missing/invalid target codes for a particular event record profile.

In general, an anomaly detection machine learning model may be a machine learning model that uses mappings of a group of event record profiles to a multi-dimensional embedding space to determine predicted subject-matter correlations between the event record profiles, where the noted subject-matter correlations may then in turn be used to determine anomaly predictions for the mapped event record profiles. For example, the anomaly detection machine learning model may be used to determine a neighboring subset for each mapped event record profile, where it may be assumed that a mapped event record profile should have a distribution of target codes that statistically corresponds to the distribution of event codes across the event record profiles in the neighboring subset for the mapped event record profile. In some embodiments, the anomaly detection machine learning model is a clustering model.

Moreover, an anomaly detection may describe the likelihood that a target code is missing from an event record profile for an event period and/or the likelihood that a target code currently associated with an event record profile for an event period should not be part of the event record profile. In some embodiments, anomaly detections may be determined using an anomaly detection machine learning model, e.g., by mapping a group of event record profiles to a multi-dimensional embedding space associated with the anomaly detection machine learning model to determine predicted subject-matter correlations between the event record profiles, followed by using the noted subject-matter correlations to determine anomaly predictions for the mapped event record profiles.

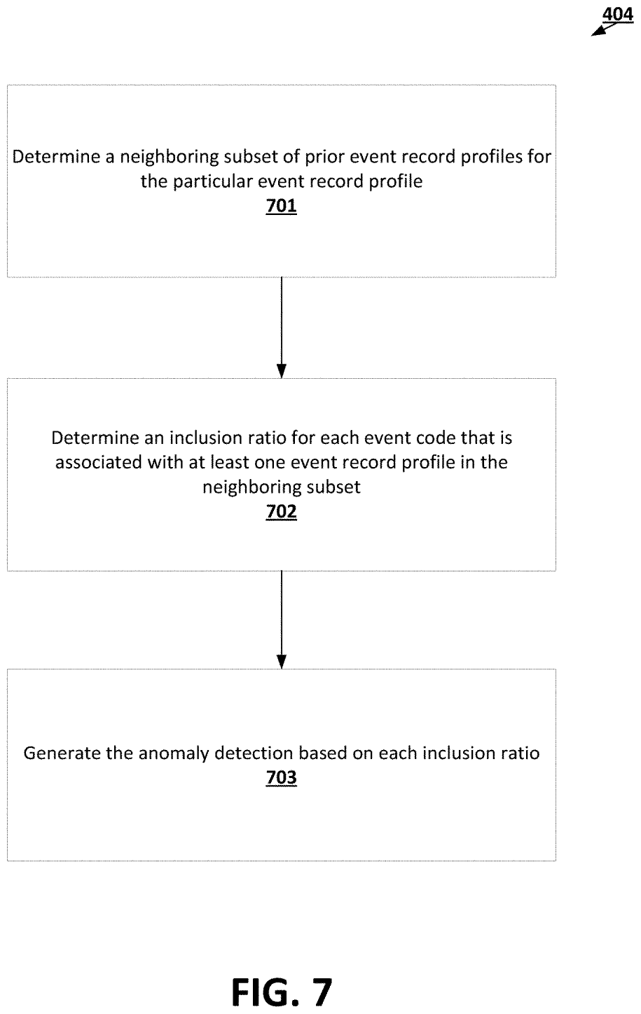

In some embodiments, step/operation 404 may be performed in relation to a particular event record profile accordance with the process depicted in FIG. 7. The process depicted in FIG. 7 begins at step/operation 701 when the predictive data analysis computing entity 106 determines a neighboring set of a group of prior event record profiles for the particular event record profile. In some embodiments, the predictive data analysis computing entity 106 maps the particular event record profile to a multi-dimensional embedding space associated with the anomaly detection machine learning model that comprises mappings of a group of prior event record profiles. Afterward, the predictive data analysis computing entity 106 generates a cross-profile distance measure between the particular event record profile and each prior event record profile of the group of prior event record profiles. Thereafter, the predictive data analysis computing entity 106 detects a neighboring subset of the group of prior event record profiles for the event record profile based at least in part on each cross-profile distance measure for a prior event record profile of the group of prior event record profiles.

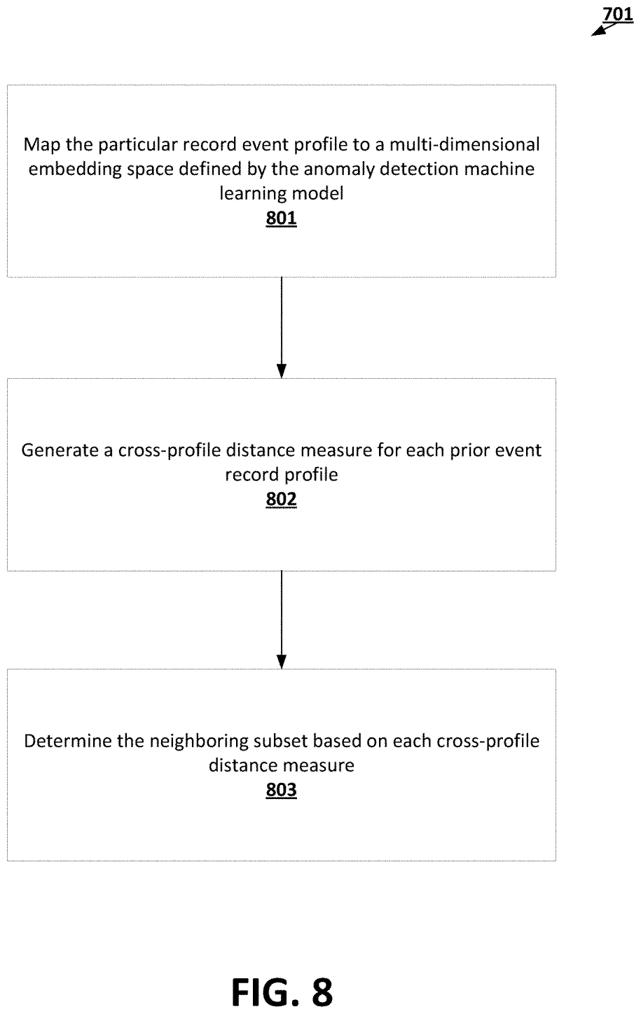

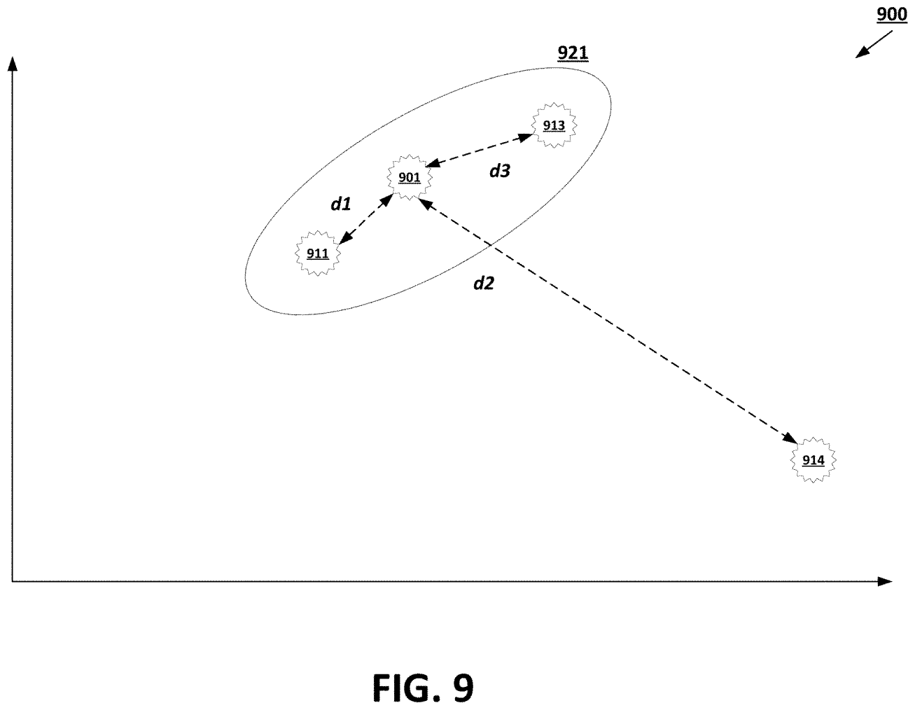

In some embodiments, step/operation 701 may be performed in accordance with the process depicted in FIG. 8. The process depicted in FIG. 8 begins at step/operation 801 when the predictive data analysis computing entity 106 maps the particular event record profile to a multi-dimensional embedding space associated with the anomaly detection machine learning model, where the multi-dimensional embedding space also includes mappings for a group of prior event record profiles. For example, as depicted in FIG. 9, the predictive data analysis computing entity 106 has mapped the particular event record profile to the mapping 901 in the multi-dimensional embedding space 900. As further depicted in FIG. 9, the multi-dimensional embedding space 900 includes a mapping 911 for a first prior event record profile, a mapping 912 for a second prior event record profile, and a mapping 913 for a third event record profile.

At step/operation 802, the predictive data analysis computing entity 106 generates a cross-profile distance measure between each prior event record profile and the particular event record profile based on a distance (e.g., a Euclidean distance, a cosine distance, a Jaccard distance, and/or the like) of the mapping of the prior event record profile and the mapping of the particular event record profile. For example, as depicted in the multi-dimensional embedding space 900 of FIG. 9, the predictive data analysis computing entity 106 has a computed a first cross-profile distance measure d1 for the first prior event record profile, a second cross-profile distance measure d2 for the second prior event record profile, and a third cross-profile distance measure d3 for the third prior event record profile.

At step/operation 803, the predictive data analysis computing entity 106 detects the neighboring subset for the particular event record profile based on each cross-profile distance measure for a prior event record profile in the group of prior event record profiles. For example, as depicted in the multi-dimensional embedding space 900 of FIG. 9, the predictive data analysis computing entity 106 has included the first prior event record profile and the third prior event record profile in the neighboring subset 921 for the particular event record profile that is associated with the mapping 901.

In some embodiments, a prior event record profile is included among the neighboring subset if the cross-profile distance measure for the prior event record profile satisfies (e.g., falls below) a cross-profile distance measure threshold value, where the cross-profile distance measure threshold value may be determined statistically using pre-runtime-provided system configuration data, determined dynamically using runtime-provided system configuration data, determined statistically based on a statistical distribution of historical cross-profile distance measure values across various recorded time periods, determined dynamically based on a statistical distribution of historical cross-profile distance measure values across various recorded time periods, determined statistically using a pre-runtime-executed trained machine learning model, determined dynamically using a runtime-executed trained machine learning model, and/or the like.

Returning to FIG. 7, at step/operation 702, the predictive data analysis computing entity 106 determines an inclusion ratio for each target code that is associated with at least one event record profile in the neighboring subset. In some embodiments, the inclusion ratio of a target code describes a ratio of a count of event record profiles in the neighboring subset that are associated with the target code to a count of all event record profiles in the neighboring subset. For example, given the neighboring subset 921 depicted in the multi-dimensional embedding space 900 of FIG. 9, if a particular target code is associated with only one of the two event record profiles in the neighboring subset 921, the particular target code may have an inclusion ratio of 0.5.

At step/operation 703, the predictive data analysis computing entity 106 generates the anomaly predictions based on each inclusion ratio for a target code that is associated with at least one event record profile in the neighboring subset. In some embodiments, if the inclusion ratio for a particular target code satisfies (e.g., falls above) a higher inclusion ratio threshold value but the particular event code is not currently associated with the particular event record profile, the predictive data analysis computing entity 106 determines an anomaly detection that recommends adding the particular target code to the event record profile with an anomaly detection probability, where the anomaly detection probability is determined based on the inclusion ratio for the particular event code. In some embodiments, if the inclusion ratio for a particular event code satisfies (e.g., falls below) a lower inclusion ratio threshold value but the particular target code is currently associated with the particular event record profile, the predictive data analysis computing entity 106 determines an anomaly detection that recommends removing the particular event code from the event record profile with an anomaly detection probability, where the anomaly detection probability is determined based on the inclusion ratio for the particular event code.

In some embodiments, at least one of the higher inclusion ratio threshold value noted above and the lower inclusion ratio threshold value noted above is determined statistically using pre-runtime-provided system configuration data, determined dynamically using runtime-provided system configuration data, determined statistically based on a statistical distribution of historical inclusion ratio values across various recorded time periods, determined dynamically based on a statistical distribution of historical inclusion ratio values across various recorded time periods, determined statistically using a pre-runtime-executed trained machine learning model, determined dynamically using a runtime-executed trained machine learning model, and/or the like.

In some embodiments, performing anomaly detection may also be based on weighted distance comparison (e.g. 1/distance\hat{ }2) of neighbors with positive expression vs negative expression, rather than classifying neighbors as in-neighborhood vs out-neighborhood (e.g. k-nearest neighbors). In some of the noted embodiments, cosine similarity can generate weights of +100% to −100% (rather than from 100% to 0%) and is able to classify objects opposite to the record of interest to give a penalty. In some embodiments, graph metrics can be used to determine if the record of interest has greater centrality to the group with positive expression compared to the group with negative expression to determine group association.

An operational example of performing step/operation 404 is depicted in FIG. 5. As depicted in FIG. 5, the event record profile 501 has been processed using an anomaly detection machine learning model to determine the inferred target codes 503 HCC19 and HCC88. Because neither of the inferred target codes 503 are among the existing target codes 502 for the event record profile 501, both of the inferred target codes 503 are listed as missing target codes 504 for the event record profile 501.

Returning to FIG. 4, at step/operation 405, the predictive data analysis computing entity 106 performs one or more prediction-based actions based on the one or more anomaly detections. In some embodiments, performing the one or more prediction-based actions comprises: for each anomaly detection of the one or more anomaly detections, determining a priority score for the anomaly prediction based at least in part on an inclusion ratio for an evet record profile of the one or more event record profiles used to generate the anomaly detection; and performing the one or more prediction-based actions based on each priority score for an anomaly detection of the one or more anomaly detections.

In some embodiments, when an anomaly detection is associated with an event record profile for a medical claim, the priority score for the anomaly detection may be determined based on the inclusion ratio for the event record profile as well as medical chart data associated with a medical chart data object for the medical claim. In some of the noted embodiments, performing the one or more prediction-based actions based on each priority score for an anomaly detection of the one or more anomaly detections comprises ranking the medical charts according to the priority scores associated with their corresponding anomaly detections and selecting medical charts for agent processing (e.g., manual agent processing, automated agent processing, and/or the like) using an optimization technique. In some embodiments, the noted optimization technique is configured to process the priority score and the HCCs associated with the anomaly detections and route the medical charts to the ideal agents (e.g., coders). Specific factors considered in the routing process include agent efficacy, agent quality, agent familiarity with specific types of charts, and agent familiarity with specific types of conditions, member risk gaps, and chart condition support. Examples of optimization techniques discussed herein that can be used to route medical charts include linear programming optimization, ant colony optimization, and/or the like.

In some embodiments, performing the prediction-based actions includes causing display of an anomaly detection user interface, where the anomaly detection user interface may display, for each anomaly detection of the one or more anomaly detections that is associated with an agent profile for the anomaly detection user interface, a reference to a related data object (e.g., a medical chart data object) associated with the anomaly detection. In some embodiments, the ordering of the related data objects in the anomaly detection user interface is determined based on the priority scores for the anomaly detections associated with the related data objects. In some embodiments, an anomaly detection user interface may display, for each anomaly detection of the one or more anomaly detections that is associated with an agent profile for the anomaly detection user interface, the priority score for the anomaly detection.

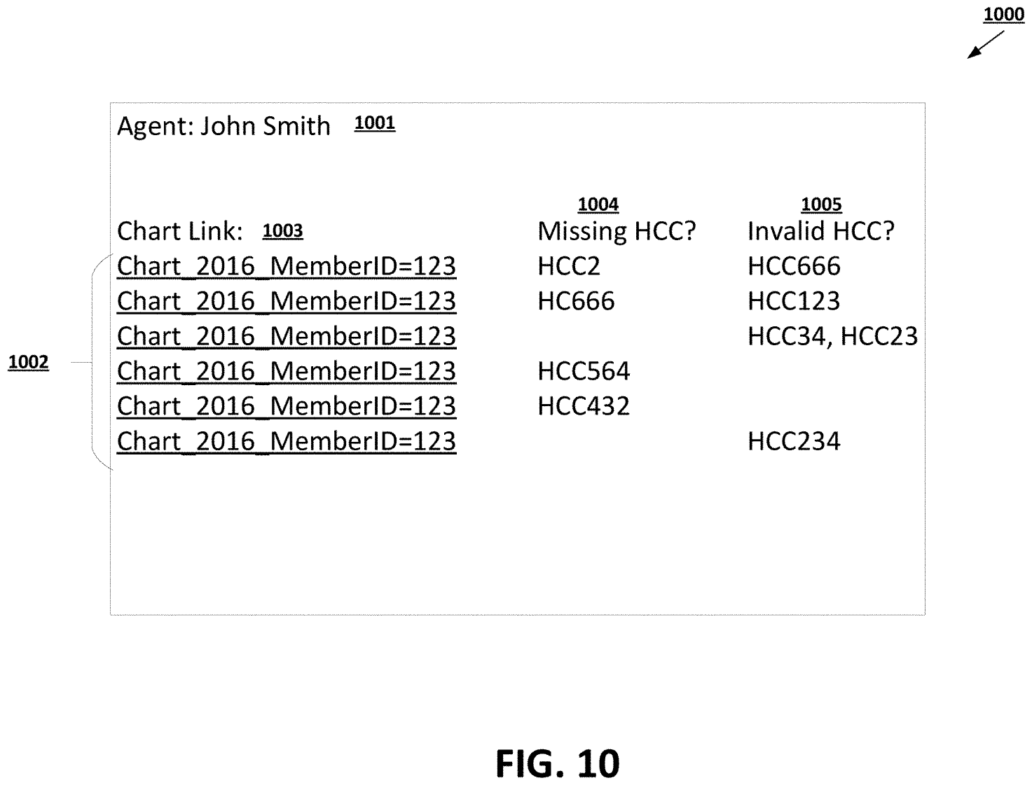

An operational example of an anomaly detection user interface 1000 is depicted in FIG. 10. As depicted in FIG. 10, the anomaly detection user interface 1000 is associated with the agent profile 1001 and includes a ranked ordering 1002 of a group of medical chart data objects, where the ranked ordering 1002 may be determined based on the priority scores of the anomaly detections associated with the group of medical chart data objects. The anomaly detection user interface 1000 includes, as part of the ranked ordering 1002, the link to the medical chart data object 1003 associated with each medical chart data object designated by the ranked ordering 1002, the list of HCCs predicted to be missing 1004 from the medical chart data object designated by the ranked ordering 1002, and the list of HCCs predicted to be invalidly present in the medical chart data object 1005 designated by the ranked ordering 1002. Other examples of prediction-based actions include automatic load balancing operations (e.g., automatic testing center load balancing operations), automatic resource allocation operations, automatic notification generation operations, and/or the like.

### VI. CONCLUSION

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A computer-implemented method for predictive anomaly detection, the computer-implemented method comprising:
identifying a plurality of event records, wherein each event record of the plurality of event records is associated with an event period of one or more event periods, an event date of one or more event dates, and an event code of one or more event codes;
for each event record of the plurality of event records, determining a temporally-related event code data object based at least in part on a temporally-related subset of the one or more event codes that is associated with the event record, wherein: (i) each event code in the temporally-related subset for a corresponding event record of the one or more event records is associated with at least one event record of the one or more event records that occurs within the event period of the corresponding event record, and (ii) each event code in the temporally-related subset for a corresponding event record of the one or more event records is associated with at least one event record of the one or more event records that occurs prior to the event date of the corresponding event record;
generating one or more event record profiles, wherein: (i) each event record profile of the one or more event record profiles is associated with an event period of the one or more event periods, and (ii) each event record profile of the one or more event record profiles describes a related subset of each temporally-related event code data object for an event record of the plurality of event records that is associated with the event period for the event record profile;
processing the one or more event record profiles using an anomaly detection machine learning model to generate one or more anomaly detection predictions; and
performing one or more prediction-based actions based at least in part on the one or more anomaly detections.

2. The computer-implemented method of claim 1, wherein each temporally-related subset for a temporally-related event code data object that is associated with a corresponding event record of the one or more event records comprises each event record of the one or more event records that occurs within the event period for the corresponding event record and that is associated with the event code for the corresponding event record.

3. The computer-implemented method of claim 2, wherein:
each event record of the one or more event records is associated with a provider identifier, and
each temporally-related subset for a temporally-related event code data object that is associated with a corresponding event record of the one or more event records comprises each event record of the one or more event records that occurs within the event period for the corresponding event record, that is associated with the event code for the corresponding event record, and that is associated with the provider identifier for the corresponding event record.

4. The computer-implemented method of claim 1, wherein generating a particular event record profile of the one or more event record profiles comprises:
generating one or more event code documents for the particular event record profile, wherein each event code document of the one or more event code documents describes the temporally-related event code data object for an event record of the plurality of event records that is associated with the event code document;
generating the particular event record profile based at least in part on the one or more event code documents for the particular event record profile.

5. The computer-implemented method of claim 4, wherein generating a particular event document code of the one or more event code documents comprises:
generating a term-frequency-inverse-document-frequency (TF-IDF) score for each event code of the one or more event codes with respect to the particular event code document; and
updating the particular event code document by removing from the particular event code document each event record in the event code document whose TF-IDF score fails to satisfy a TF-IDF score threshold value.

6. The computer-implemented method of claim 1, wherein generating one or more anomaly detection predictions comprises:
for each event record profile of the one or more event record profiles:
mapping the event record profile to a multi-dimensional embedding space associated with the anomaly detection machine learning model that comprises mappings of a group of prior event record profiles;
for each prior event record profile of the group of prior event record profiles, generating a cross-profile distance measure between the event record profile and the prior event record profile;
detecting a neighboring subset of the group of prior event record profiles for the event record profile based at least in part on each cross-profile distance measure for a prior event record profile of the group of prior event record profiles;
for each target code of one or more target codes that is associated with at least one event record profile in the neighboring subset, determining an inclusion ratio of a count of event record profiles in the neighboring set that are associated with the target code to a total count of event record profiles in the neighboring set; and
generating an anomaly detection of the one or more anomaly detection predictions based at least in part on each inclusion ratio for a target code of the one or more target codes that is associated with at least one event record in the neighboring subset.

7. The computer-implemented method of claim 1, wherein performing the one or more prediction-based actions comprises:
for each anomaly detection of the one or more anomaly detections, determining a priority score for the anomaly prediction based at least in part on an inclusion ratio for an event record profile of the one or more event record profiles used to generate the anomaly detection; and
performing the one or more prediction-based actions based at least in part on each priority score for an anomaly detection of the one or more anomaly detections.

8. The computer-implemented method of claim 1, wherein the one or more event records comprise one or more medical service performance records.

9. The computer-implemented method of claim 1, wherein the one or more event codes comprise one or more diagnosis codes.

10. An apparatus for predictive anomaly detection, the apparatus comprising at least one processor and at least one memory including program code, the at least one memory and the program code configured to, with the processor, cause the apparatus to at least:
identify a plurality of event records, wherein each event record of the plurality of event records is associated with an event period of one or more event periods, an event date of one or more event dates, and an event code of one or more event codes;
for each event record of the plurality of event records, determine a temporally-related event code data object based at least in part on a temporally-related subset of the one or more event codes that is associated with the event record, wherein: (i) each event code in the temporally-related subset for a corresponding event record of the one or more event records is associated with at least one event record of the one or more event records that occurs within the event period of the corresponding event record, and (ii) each event code in the temporally-related subset for a corresponding event record of the one or more event records is associated with at least one event record of the one or more event records that occurs prior to the event date of the corresponding event record;
generate one or more event record profiles, wherein: (i) each event record profile of the one or more event record profiles is associated with an event period of the one or more event periods, and (ii) each event record profile of the one or more event record profiles describes a related subset of each temporally-related event code data object for an event record of the plurality of event records that is associated with the event period for the event record profile;
process the one or more event record profiles using an anomaly detection machine learning model to generate one or more anomaly detection predictions; and
perform one or more prediction-based actions based at least in part on the one or more anomaly detections.

11. The apparatus of claim 10, wherein generating a particular event record profile of the one or more event record profiles comprises:
generating one or more event code documents for the particular event record profile, wherein each event code document of the one or more event code documents describes the temporally-related event code data object for an event record of the plurality of event records that is associated with the event code document;
generating the particular event record profile based at least in part on the one or more event code documents for the particular event record profile.

12. The apparatus of claim 11, wherein generating a particular event document code of the one or more event code documents comprises:
generating a term-frequency-inverse-document-frequency (TF-IDF) score for each event code of the one or more event codes with respect to the particular event code document; and
updating the particular event code document by removing from the particular event code document each event record in the event code document whose TF-IDF score fails to satisfy a TF-IDF score threshold value.

13. The apparatus of claim 10, wherein generating one or more anomaly detection predictions comprises:
for each event record profile of the one or more event record profiles:
mapping the event record profile to a multi-dimensional embedding space associated with the anomaly detection machine learning model that comprises mappings of a group of prior event record profiles;
for each prior event record profile of the group of prior event record profiles, generating a cross-profile distance measure between the event record profile and the prior event record profile;
detecting a neighboring subset of the group of prior event record profiles for the event record profile based at least in part on each cross-profile distance measure for a prior event record profile of the group of prior event record profiles;
for each event code of one or more target codes that is associated with at least one event record profile in the neighboring subset, determining an inclusion ratio of a count of event record profiles in the neighboring set that are associated with the target code to a total count of event record profiles in the neighboring set; and
generating an anomaly detection of the one or more anomaly detection predictions based at least in part on each inclusion ratio for a target code of the one or more target codes that is associated with at least one event record in the neighboring subset.

14. The apparatus of claim 10, wherein performing the one or more prediction-based actions comprises:
for each anomaly detection of the one or more anomaly detections, determining a priority score for the anomaly prediction based at least in part on an inclusion ratio for an event record profile of the one or more event record profiles used to generate the anomaly detection; and
performing the one or more prediction-based actions based at least in part on each priority score for an anomaly detection of the one or more anomaly detections.

15. The apparatus of claim 11, wherein each temporally-related subset for a temporally-related event code data object that is associated with a corresponding event record of the one or more event records comprises each event record of the one or more event records that occurs within the event period for the corresponding event record and that is associated with the event code for the corresponding event record.

16. A computer program product for predictive anomaly detection, the computer program product comprising at least one non-transitory computer-readable storage medium having computer-readable program code portions stored therein, the computer-readable program code portions configured to:
identify a plurality of event records, wherein each event record of the plurality of event records is associated with an event period of one or more event periods, an event date of one or more event dates, and an event code of one or more event codes;
for each event record of the plurality of event records, determine a temporally-related event code data object based at least in part on a temporally-related subset of the one or more event codes that is associated with the event record, wherein: (i) each event code in the temporally-related subset for a corresponding event record of the one or more event records is associated with at least one event record of the one or more event records that occurs within the event period of the corresponding event record, and (ii) each event code in the temporally-related subset for a corresponding event record of the one or more event records is associated with at least one event record of the one or more event records that occurs prior to the event date of the corresponding event record;
generate one or more event record profiles, wherein: (i) each event record profile of the one or more event record profiles is associated with an event period of the one or more event periods, and (ii) each event record profile of the one or more event record profiles describes a related subset of each temporally-related event code data object for an event record of the plurality of event records that is associated with the event period for the event record profile;
process the one or more event record profiles using an anomaly detection machine learning model to generate one or more anomaly detection predictions; and
perform one or more prediction-based actions based at least in part on the one or more anomaly detections.

17. The computer program product of claim 16, wherein generating a particular event record profile of the one or more event record profiles comprises:
generating one or more event code documents for the particular event record profile, wherein each event code document of the one or more event code documents describes the temporally-related event code data object for an event record of the plurality of event records that is associated with the event code document;
generating the particular event record profile based at least in part on the one or more event code documents for the particular event record profile.

18. The computer program product of claim 17, wherein generating a particular event document code of the one or more event code documents comprises:
generating a term-frequency-inverse-document-frequency (TF-IDF) score for each event code of the one or more event codes with respect to the particular event code document; and
updating the particular event code document by removing from the particular event code document each event record in the event code document whose TF-IDF score fails to satisfy a TF-IDF score threshold value.

19. The computer program product of claim 16, wherein generating one or more anomaly detection predictions comprises:
for each event record profile of the one or more event record profiles:
mapping the event record profile to a multi-dimensional embedding space associated with the anomaly detection machine learning model that comprises mappings of a group of prior event record profiles;
for each prior event record profile of the group of prior event record profiles, generating a cross-profile distance measure between the event record profile and the prior event record profile;
detecting a neighboring subset of the group of prior event record profiles for the event record profile based at least in part on each cross-profile distance measure for a prior event record profile of the group of prior event record profiles;
for each target code of the one or more target codes that is associated with at least one event record profile in the neighboring subset, determining an inclusion ratio of a count of event record profiles in the neighboring set that are associated with the target code to a total count of event record profiles in the neighboring set; and
generating an anomaly detection of the one or more anomaly detection predictions based at least in part on each inclusion ratio for an event code of the one or more event codes that is associated with at least one event record in the neighboring subset.

20. The computer program product of claim 16, wherein performing the one or more prediction-based actions comprises:
for each anomaly detection of the one or more anomaly detections, determining a priority score for the anomaly prediction based at least in part on an inclusion ratio for an event record profile of the one or more event record profiles used to generate the anomaly detection; and
performing the one or more prediction-based actions based at least in part on each priority score for an anomaly detection of the one or more anomaly detections.
